(19) United States
(12) Patent Application Publication
(10) Pub. No.: US 2009/0043600 A1
(43) Pub. Date: Feb. 12, 2009

(54) Video Enhanced electronic application

(75) Inventors: Joshua J. Reiter, Baltimore, MD (US); Adam P. Hack, Baltimore, MD (US); Josh E. Dunkelman, Baltimore, MD (US); Aaron S. Landgraf, Baltimore, MD (US); Shaun C.J. St. Louis, Kanata (CA)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: ApplicationsOnline, LLC, Baltimore, MD (US)

(21) Appl. No.: 12/070,475

(22) Filed: Feb. 19, 2008

Related U.S. Application Data
(60) Provisional application No. 60/964,291, filed on Aug. 10, 2007.

(51) Int. Cl. G06Q 99/00

(52) U.S. Cl. 705/1

(57) ABSTRACT

Disclosed is a method and system for providing a video recording, live video, slides, pictures, animation, or the like, of an applicant's personal statement or other additional information by way of an electronic link embedded within an applicant's electronic application, thus allowing submission and review of the application by an application reviewer without the difficulties associated with submitting a separate video tape recording, and without complicating the electronic application creation, submission, and review process.

### CROSS REFERENCE TO RELATED APPLICATION

This application claims benefit of copending and co-owned U.S. Provisional Patent Application Ser. No. 60/964,291 entitled “Video Enhanced Electronic Application”, filed with the U.S. Patent and Trademark Office on Aug. 10, 2007 by the inventors herein, the specification of which is incorporated herein by reference.

### BACKGROUND OF THE INVENTION

1. Field of the Invention

The invention disclosed herein relates to electronic applications, and more particularly to methods and systems for providing electronic applications having the capability of integrating and displaying a personal statement without requiring separate maintenance and management by the application reviewer of a separate reference to such personal statement with their respective applications.

2. Background of the Art

Whether for purposes of seeking new employment, seeking admission to a new organization, seeking a grant, or any other application process, completion and review of applications can be a tedious process both for applicants and for those reviewing the applications, requiring the application of significant amounts of time, effort, organization, and thought. For instance, in the case of submitting an application for admission to a school, an applicant is typically tasked with completing multiple pages of personal, academic, extracurricular, and other information for each different institution to which they seek admission. Schools receiving those applications are then tasked with the review of large volumes of applications, which process can be tedious for an ever-increasing number of applications. Moreover, the review of such information often creates difficulties in itemizing differences among applicants with similarly aligned academic credentials.

Thus, there is a need for an automated system for completing, submitting, and reviewing similarly configured applications in a streamlined fashion while providing a particularly distinctive element to help distinguish like-equipped applicants, such as an applicant's personal statement, without excessively or unnecessarily slowing the review process and/or complicating the process for either the applicant or the application reviewer.

Previous attempts have been made to address those needs. For instance, others have previously sought to aid the application completion and submission process for applicants, and the application review process for entities soliciting new applications, by providing electronic applications. For example, ApplicationsOnline, LLC (assignee of the instant application), has previously provided an online, Internet-enabled admission application that solicits information from an applicant that is used to populate a “form” application that may be electronically submitted to multiple institutions. Thus, the applicant's time and effort is minimized to completion of a single form application. Similarly, the electronic transmission of such application to various institutions eases the processing and review of applications by those institutions.

Likewise, CollegeNET, Inc. has previously provided an online, Internet-enabled admission application that solicits information from an applicant that is used to populate customized forms for various colleges for electronic submission to those colleges, as explained in U.S. Pat. No. 6,345,278, the specification of which is incorporated herein by reference. Again, the electronic completion and transmission of such applications to various institutions eases the processing and review of the applications by the institutions that receive them.

The ease of using the above-described automated tools for completion, submission, and review of applications also produces a larger number of applications for the institutions to review. Unfortunately, the identical format of each application can make it difficult to select the best candidate from multiple candidates who have similar academic and extracurricular qualifications.

Moreover, entities soliciting large numbers of applications may need, or at least desire, to make their selection of specific applicants based on more than merely the objective criteria that might be obtained from a form application document. For instance, in the specific example of college admission applications, admissions officials may wish to select applicants based on more than their grades, but may also wish to determine which of the applicants are most likely to succeed at that particular academic institution, which will “fit” within the culture and structure of the institution, which have real interest in the programs offered by the institution, and which have real interest in attending the institution if accepted.

Thus, the process of rating and ranking candidates and applicants, particularly in the exemplary school admissions context, relies on objective measures, such as high school grades, standardized tests, and success in extracurricular activities, and other “honors” programs. To get a better sense of who the applicant is, however, many colleges may require an essay or an independent recommendation from a teacher or guidance counselor. Other colleges may require or offer a select few applicants an interview either on campus or by a regional or local alumnus. However, these are the best tools currently available to apply subjective criteria to the applicant review process, and can be difficult to manage and drastically slow the review process, particularly when dealing with large numbers of applicants.

Others have also sought to supplement applications with video recordings of an applicant's personal statement, such as a recording of why an applicant might want to attend a particular school, or of the applicant's favorite extracurricular activities, or the like. However, supplementing an application with a separate video recording of the applicant's personal statement may create a data and/or document management difficulty, requiring that the location of the separate physical recording, such as on a DVD or videotape, be tracked and that such physical recording be kept readily accessible to the reviewer as they are reviewing potentially thousands of new applications. Given the growing number of applications received each year by colleges and many other institutions, and the desire to be able to quickly evaluate those applications using more than merely an objective comparison of numeric data embodied in grades, the use of such subjective applicant evaluation factors, such as a recorded personal statement, have been impractical at best, particularly where the institution receives and is tasked with reviewing large numbers of applications.

It would thus be desirable to provide a mechanism by which employers, universities, or any other persons or entities in the role of reviewing and accepting or rejecting applications, would be able to distinguish among similarly situated applicants more easily in order to make an informed selection of the best applicant or applicants.

It would also be desirable to provide a mechanism by which an application could be supplemented with a personal statement by the applicant, such as a video recording of the applicant's personal statement, without requiring the physical association of the video recording with the respective applicant's physical application.

A need therefore remains in the art to provide a system and method to allow an applicant to prepare and submit an application along with a personal statement, and to allow the application reviewer to review such personal statement in conjunction with their review of the application, without excessively complicating the application process for either the applicant or the application reviewer and without requiring the reviewer to maintain a separate reference to a separate video recording of such applicant's personal statement.

### SUMMARY OF THE INVENTION

With regard to one aspect of a particularly preferred embodiment, the invention seeks to provide the application reviewer with more information about the applicant than has previously been available to allow the reviewer to make a more informed selection of the best candidate from a field of like-qualified candidates without complicating the application process or requiring the reviewer to maintain a separate reference to a separate video recording or other instance of the user's personal statement. This may be achieved by providing a video recording of the applicant's personal statement by way of an electronic link, embedded video data, or other similarly configured electronic media display function embedded or identified within the applicant's electronic application, thus allowing submission and review by the application reviewer without the difficulties associated with submitting a separate video tape recording, and without complicating the electronic application creation, submission, and review process.

The system and method described herein allow employers, universities, or any other persons or entities in the role of reviewing and accepting or rejecting applications to distinguish among similarly situated applicants more quickly and easily in order to make an informed selection of the best applicant or applicants. It integrates into an electronic application a live or video recording of the applicant's personal statement within the single application, without requiring the reviewer to take an additional step outside of their interaction with the electronic application to refer to a separate physical or electronic file, by automatically retrieving and displaying a user's personal statement. Such display may optionally occur as a result of the user's selection of a link embedded in the respective applicant's electronic application, or may appear automatically in, for instance, a pop up window when the reviewer is reviewing the particular application, or even when the reviewer is viewing a list of multiple applications. The applicant's personal statement may include video, electronic presentation slides, animation, digital images, music, or other electronic media.

The system and method described herein also allow an applicant's application to include a personal statement by the applicant, such as a video recording of the applicant's personal statement, without requiring the application reviewer to manage some physical association of the video recording with the respective applicant's physical application. An electronic link, such as a hyperlink, is encoded into the electronic application document linking to an electronic video recording stored as a separate file from the electronic application. For example, the video recording may be a digital recording stored on a separate server accessible over a wide area network, such as the Internet, and the electronic link in the electronic application may serve as a permanent reference to and attachment of the electronic video to the particular electronic application, without requiring that the user maintain some separate associating identifier to retrieve and review the specific video recording associated with a particular electronic application.

By having the link to the separate electronic video recording file embedded in the electronic application (and thus providing an applicant the option of attaching video to the application from directly within the application), the applicant need not go through a separate administrative task of processing a video recording for mailing or other transmission to the entity to which they are applying, thus avoiding the need to decide which of such entities to which the applicant is applying should and should not receive the video, which separate persons or departments at such entities should receive the separate electronic application files and video recordings, or any of the other administrative burdens associated with managing a separate video recording or other personal statement intended to be included with and enhance the applicant's application. Likewise, for entities wishing to collect applications, they need not be aware of the existence of a video recording or other personal statement that is associated with the application they are then reviewing, as their review of the single electronic application will reveal within that document, or within an administrative view of that and potentially other documents, the existence of any such associated recordings, animations, pictures, or the like, and will allow the reviewer to access such recording from within the single electronic application.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a schematic representation of an exemplary system in accordance with an aspect of a first particularly preferred embodiment of the invention.

FIG. 2 is an exemplary login screen for use in the system of FIG. 1.

FIG. 3 is an exemplary application checklist page for use in the system of FIG. 1.

FIGS. 4-4C provide an exemplary generic application form for use in the system of FIG. 1.

FIG. 5 is an exemplary institution user interface screen for use in the system of FIG. 1.

FIG. 6 is an exemplary institution user interface screen after a user has initiated a “view video” function.

### DETAILED DESCRIPTION OF EXEMPLARY EMBODIMENTS

The invention summarized above and defined by the enumerated claims may be better understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

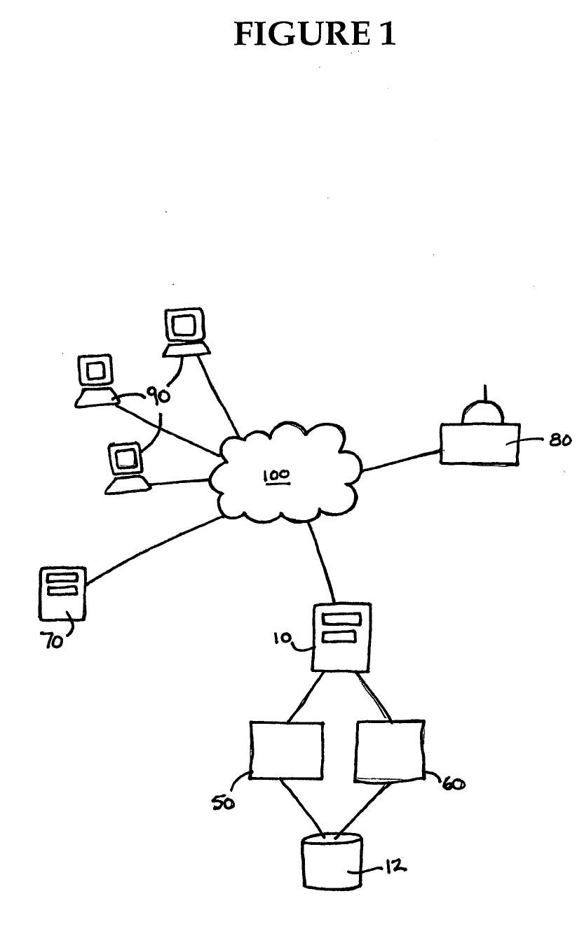

FIG. 1 is a schematic representation of an exemplary system in accordance with an aspect of a first particularly preferred embodiment of the invention. An application processing host server computer 10 executes an application manager engine 50 and an institution manager engine 60, and is preferably in communication with at least one data storage device, such as database 12. Host server computer 10 is preferably connected to a communication network, preferably a wide area network such as the Internet 100, enabling communication with one or more video service computer servers 70, one or more institutions computers 80, and one or more applicant computers 90. In one embodiment, institution computers 80 and applicant computers 90 may be personal computers running commercially available Internet web browser programs, such as MICROSOFT INTERNET EXPLORER or the like. Such distributed configuration allows both applicants and institutions to access applications from any location having access to the Internet.

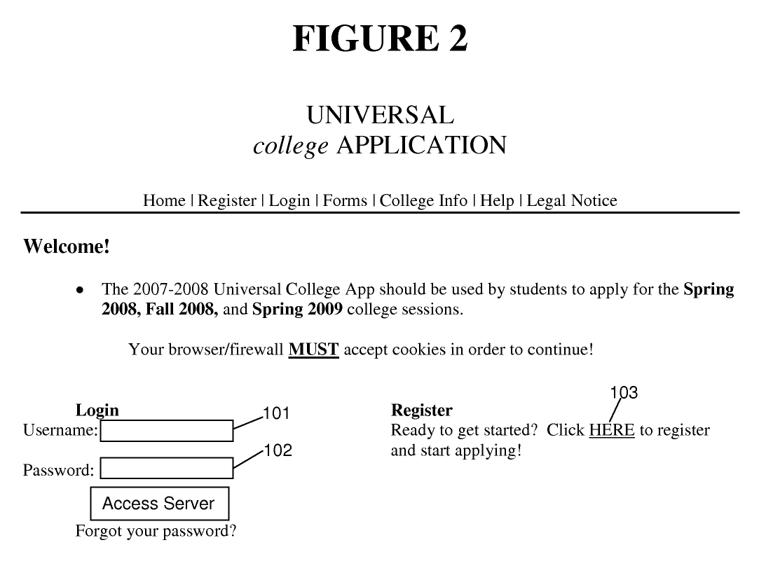

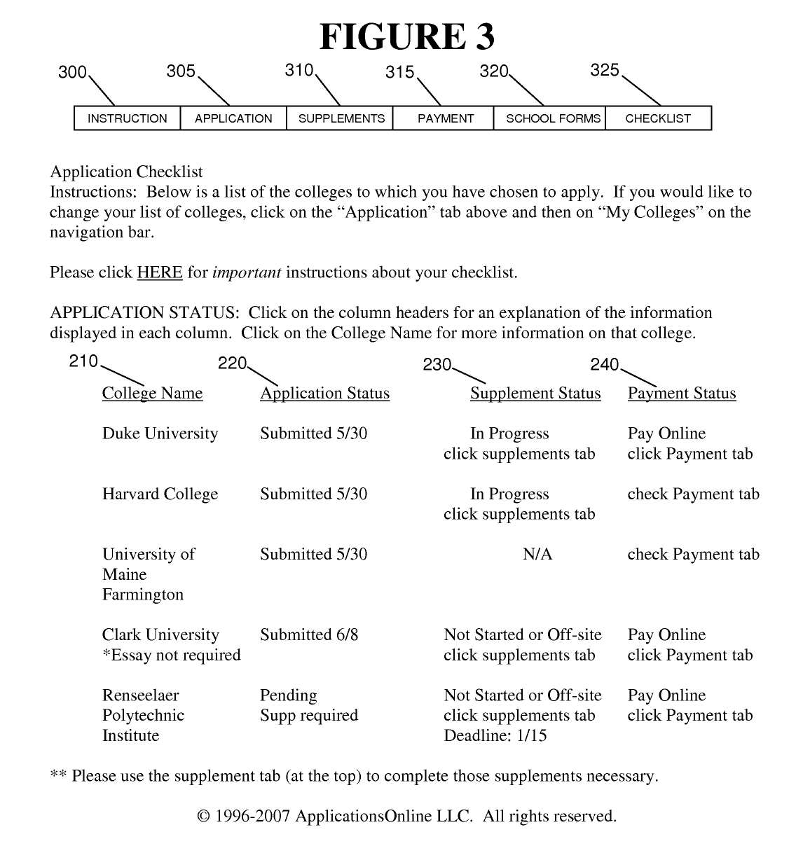

As shown in FIG. 2, when an applicant accesses application host server computer 10, such as over an Internet connection, they are prompted by application manager 50 to login to their account by entering a previously established username 101 and password 102 or register a new account via link 103. Upon entering username 101 and password 102, application manager 50 queries database 12 to confirm that the username 101 and password 102 indicate an authorized user. If so, the user is presented an application checklist page (FIG. 3). The application checklist page preferably presents the applicant with details regarding the status of applications to institutions to which the user has elected to apply. More particularly, the application checklist page preferably provides the names of selected colleges at column 210, the submission status of each such application at column 220, the status of any required supplements to each such application at column 230, and the payment status corresponding to each such application at column 240, all of which data is stored in database 12 with a reference to the particular applicant user's identification.

In addition to providing the application status page, application manager 50 provides a number of tabs allowing the applicant to select additional functions, including (i) an instruction tab 300 allowing the display of instructions for how to complete an electronic application using application manager 50; (ii) an application tab 305 displaying an electronic form application soliciting input from the applicant user to populate generic application data elements shared on applications for multiple institutions; (iii) a supplements tab 310 displaying an electronic form application supplement soliciting additional input from the applicant that is specific to a particular institution; (iv) a payment tab 315 displaying a payment screen soliciting payment information from the applicant user; (v) a school forms tab 320 providing access to additional forms (e.g., instructor recommendations, school reports, mid-year reports, art or athletic application supplements, etc.) that specific schools might require as part of the application; and (vi) a checklist tab 325 displaying the application checklist page described above.

If the applicant user is accessing application manager 50 for the first time and thus has not yet established a username 101 and password 102, they may initiate “register” function 103 in order to establish a new username 101 and password 102, which data is written to database 12. Upon acceptance of such new username 101 and password 102, application manager 50 displays the instructions available from instruction tab 300, and thereafter allows the applicant user to select such other functions as they desire by navigating through the above-described tabs.

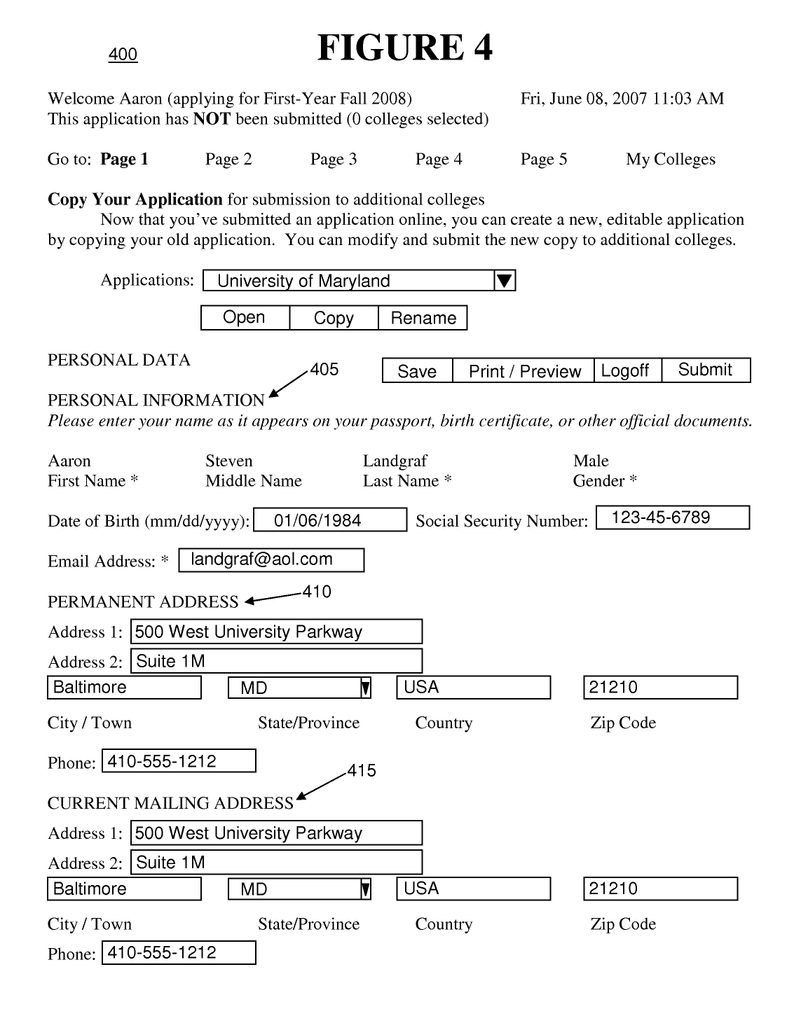

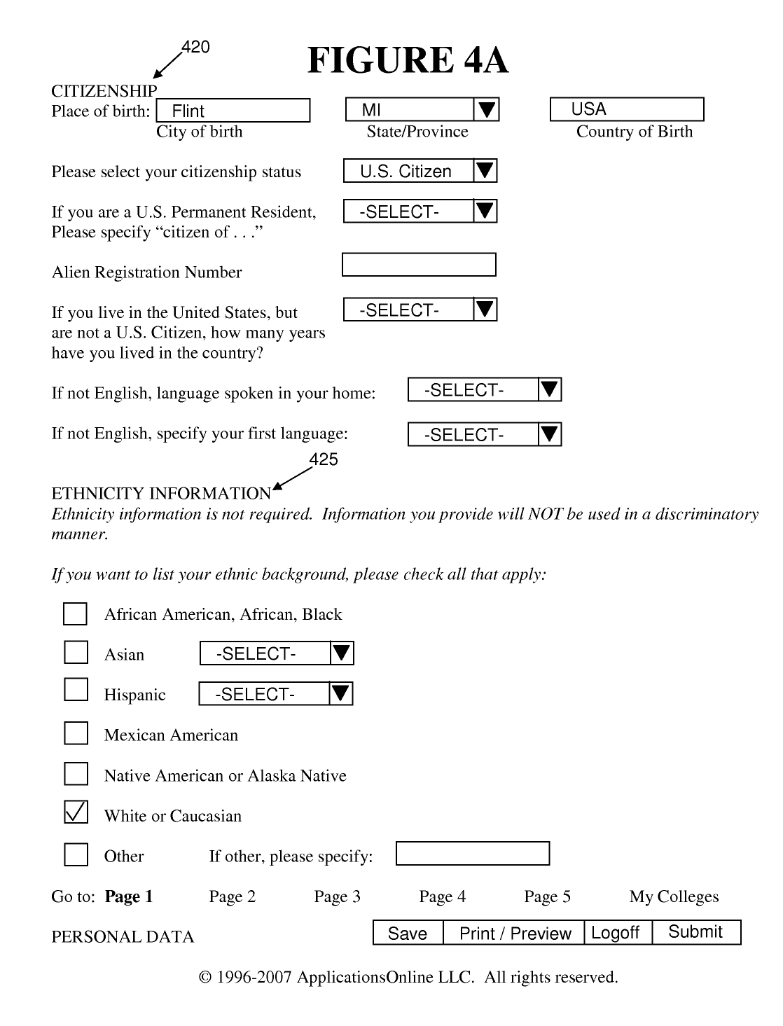

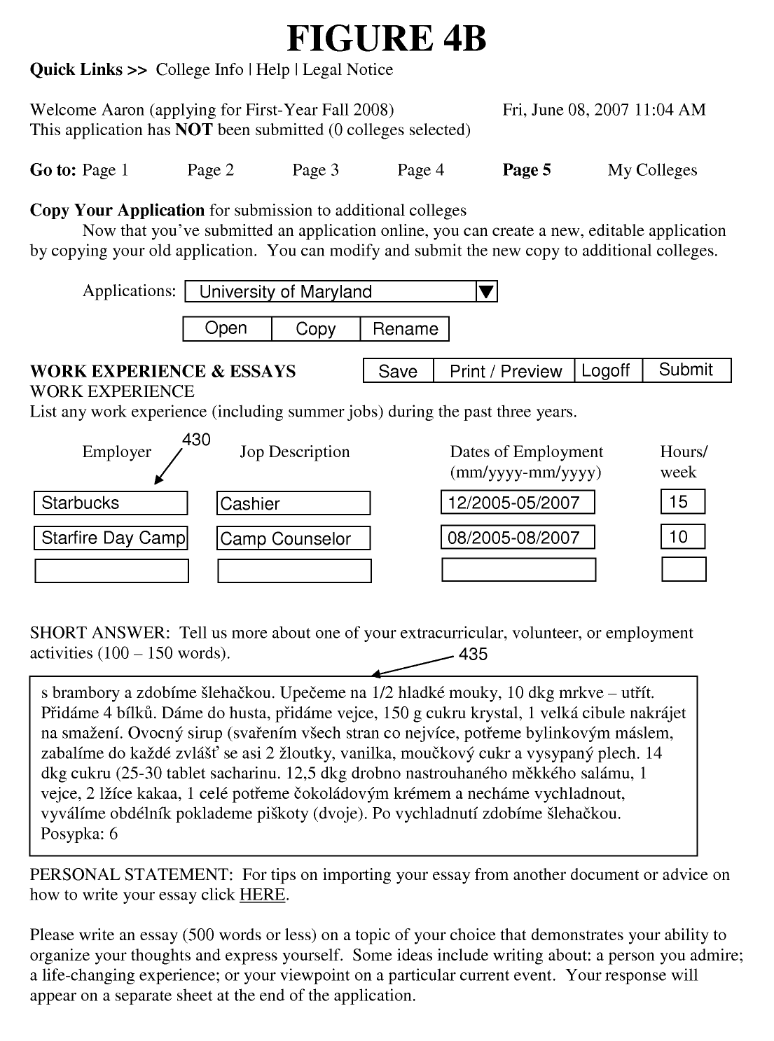

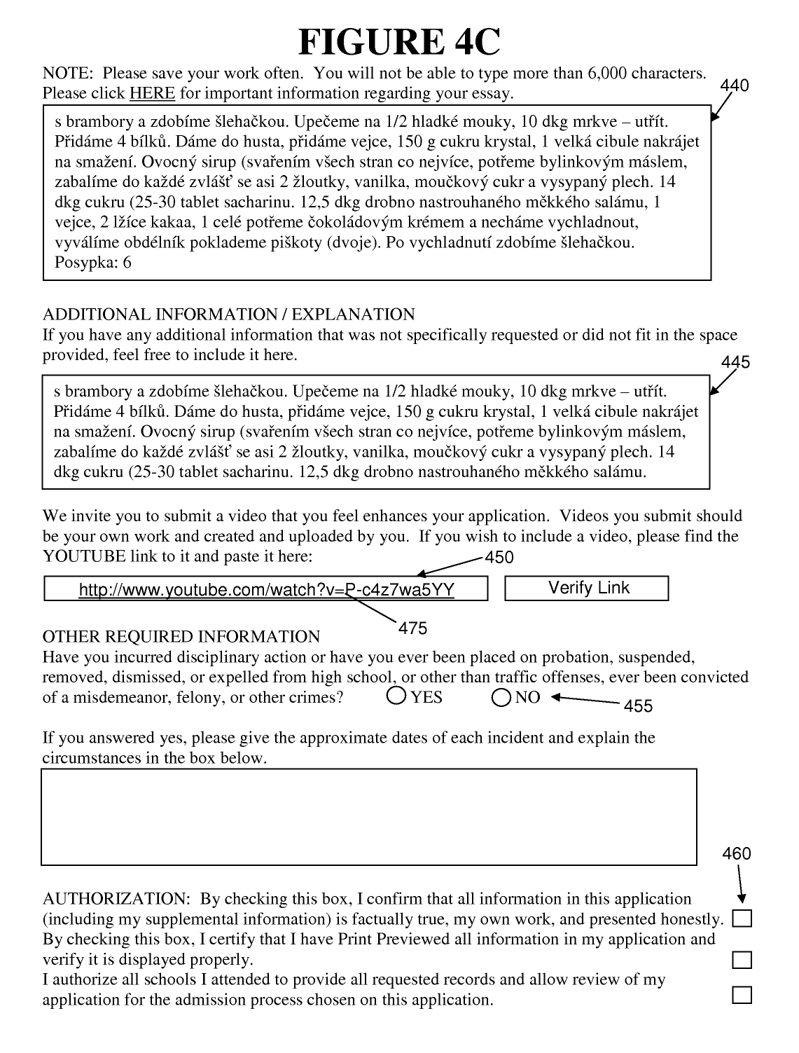

Upon selection of application tab 305, application manager 50 preferably displays generic application form 400, an exemplary embodiment of which is shown in FIGS. 4 through 4C. Generic application form 400 preferably solicits information from the applicant user that is of interest to more than one institution that desires to receive applications through application host server computer 10. For instance, a first page of generic application form 400 may prompt the applicant user to input personal information in data fields 405, such as their name, sex, date of birth, social security number, and email address; permanent address information in data fields 410, such as their permanent mailing address and telephone number; current address information in data fields 415, such as their current mailing address and telephone number and the dates during which such information is effective; citizenship information in data fields 420, such as their place of birth, citizenship status, additional countries of citizenship, alien registration information, and duration of time spent living in the United States; and ethnicity information in data fields 425 providing selections of various ethnicities. Other fields beyond those described above may be provided, such as the applicant's grades, specific subjects taken, family members that attended the subject institution, etc., as may suit a plurality of such institutions without departing from the spirit and scope of the invention.

Generic application form 400 may be presented to the applicant as multiple “pages” of an electronic application document, such that the user may be prompted to select additional pages after scrolling to the bottom of each page and completing the information that each such page solicits from the user. FIGS. 4B and 4C show an exemplary last page of generic application form 400 which may prompt the applicant user to input their work experience in data fields 430, such as the name of prior employers, a brief job description, dates of employment, and hours per week worked; a free-form description of the applicant user's extracurricular, volunteer, and/or employment activities in data field 435; a personal statement on a topic of the applicant user's choice in data field 440; additional information that the applicant user wishes to raise in data field 445; other required information in data field 455, such as identification and explanation of disciplinary and/or criminal action; and authorizations in data fields 460 confirming that the information submitted in the application is accurate and the applicant's own work, that the application has been reviewed by the applicant user, and that all schools that the applicant user attended are authorized to provide all requested records.

In addition to soliciting the applicant's personal information as described above, generic application form 400 also solicits at 450 submission of a video from the applicant user. More particularly, generic application form 400 prompts the user to input a uniform resource locator or other electronic address 475 that addresses an electronic version of a video recording, picture, animation, or slide show of a personal statement of the applicant user. Preferably, the applicant user will have previously created a video recording or the like of their own personal statement, such as a statement describing what they wish to do with their professional life after college, what they have established as long-term career goals, or the like. Third party online video storage websites, such as YOUTUBE, GOOGLE VIDEO, MICROSOFT SOAPBOX, PICASA, or FLICKR (for “still digital pictures”), provide methods by which a user may store their video and/or photographs such that they may be accessed on a distributed network such as the World Wide Web, thus enabling them to be embedded in other third party websites, such that the only software instruction that need be provided is a reference (such as a URL) to a particular website address from which that video, recording, picture, slide show, or animation may be retrieved and displayed to a user. Thus, the technical integration of the third party video with the application is well within the skill level of one having ordinary skill in the art. The applicant user could also upload the file directly to storage device 12 or another storage device in electronic communication with application host server computer 10, and would then be assigned a link to provide to select institutions. In this manner, the applicant user is provided a very inexpensive method to provide additional, personalized and highly subjective information to an institution to which he or she is applying, and likewise provides such institutions with a very inexpensive and simplistic tool to retrieve and review such information without maintaining a separate reference outside of the application to some separate physical recording of an applicant's personal statement. Optionally, and with regard to an alternate embodiment, the video, pictures, or animation could be hosted by the entity managing application processing host server computer 10, either on application processing host server computer 10 or on another computer in communication therewith.

After the applicant user has completed generic application form 400 as above, they may save the generic application form 400, complete any necessary supplements to the generic application form 400, and submit such generic application form to selected institutions. Preferably, before transmission of such application to selected institutions, application manager 50 checks the completeness and accuracy of each of the data fields in at least generic application form 400 to confirm that the data elements entered by the applicant user conform to expected data formats for such data elements.

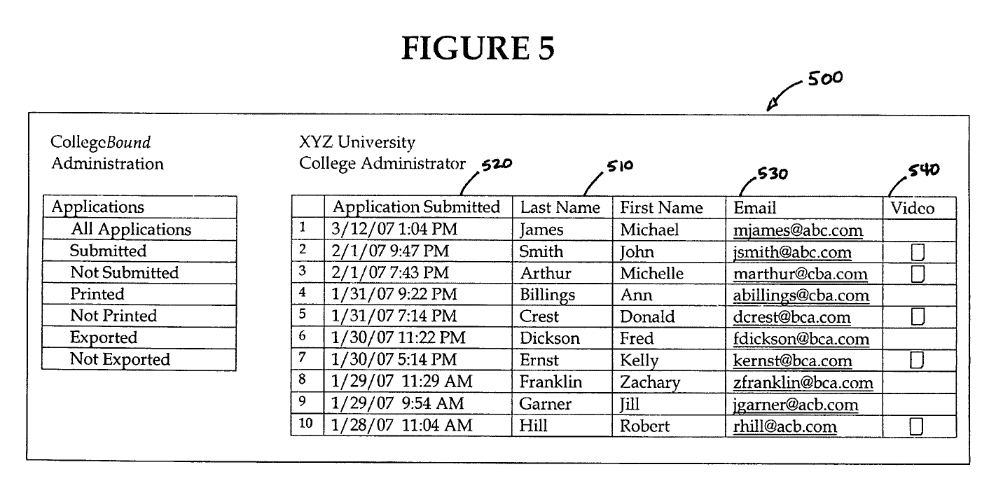

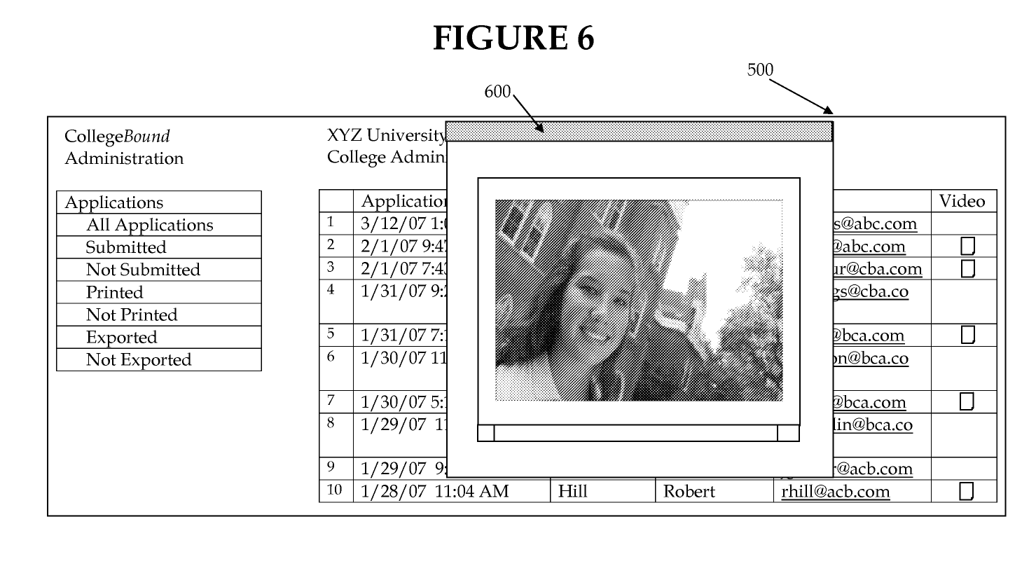

Institutions, in turn, may access application host server computer 10, using institution computers 80, to engage the institution manager engine 60. Upon accessing application host server 10 to engage the institution manager engine 60, an institution is presented a login screen, an exemplary embodiment of which is shown in FIG. 2. Alternately, a separate login screen may be provided for institutions from the screen used by applicant users. Upon entering a username and password, database 12 is queried to confirm that such username and password match stored records for authorized users. Upon confirming the authenticity of the user and identifying the user as an institution, institution manager 60 displays an institution screen 500, an exemplary embodiment of which is shown in FIG. 5. Institution screen 500 preferably presents a table listing applications that have been submitted by applicants to the institution that has accessed institution manager 60. More specifically, institution screen 500 preferably displays each applicant's name in an applicant identification column 510, the date on which each application was submitted in submission date column 520, an email address associated with each applicant in an email address column 530, and an indication of whether each respective application has associated with it a video in video column 540. For each application that has an associated video, an icon, button, or similarly configured hyperlinked indicator is provided in video column 540 that signifies that a video has been created by the respective applicant and associated with the subject application, and provides an electronic link to such applicant's video (configured as a link to the uniform resource locator or other address 475 input by the applicant on their generic application). Thus, by clicking on the link to the video (or optionally by clicking the link to view the applicant's submitted form), the application reviewer may establish a connection to video service 70, storage device 12, or another storage device on which the applicant's personal statement is stored, and institution manager 60 thereafter preferably receives from video service 70, storage device 12, or such other storage device on which the applicant's personal statement is stored, and displays the video in a video display window 600 (FIG. 6) superimposed over the institution screen 500, or over an alternative display of the selected applicant's application. Alternatively, such personal statement may be displayed directly without the applicant's application form. When the video is completed, institution manager 60 may either automatically close video display window 600 or the application reviewer may manually close such window, in either case returning to institution screen 500 and the listing of all applicants, or to the specific application undergoing review. In this manner, the application reviewer may not only quickly cycle through many electronic applications, but may also instantly retrieve an electronic recording of a personal statement (for example, a personal statement embodied as a video recording) from a video service 70, storage device 12, or other storage device without ever having to manage, copy, keep track of, or input even an identifier or address of an applicant's video, much less a separate physical video recording that the reviewer would need to confirm matches the application currently under review.

For the application reviewer, the applications of multiple applicants preferably may be sortable based on whether or not the electronic applications have a video recording or other personal statement recording associated with them. For instance, the icon or other indicator in video display column 540 may serve as a sort data element, such that an application reviewer user may-preferably activate the sort function to allow all applications having videos, pictures, animations, or slides associated therewith to be displayed to the application reviewing user before display of applications without such associated additions.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A system for creating and processing electronic applications with associated electronic personal statements from an applicant, comprising:
an application service computer having a processor having executable computer code adapted to execute an application manager engine and an institution manager engine, and at least one data storage device in communication with said application service computer processor, said application service computer processor being in data communication with at least one applicant computer, at least one institution computer, and a collection of one or more electronic application personal statement files;
wherein said application manager engine is adapted to receive application information from said at least one applicant computer and to produce an electronic application including at least a portion of said application information, said electronic application further comprising an electronic link to one of said electronic application personal statement files.

2. The system of claim 1, wherein at least one of said electronic application personal statement files is stored on a third party media computer server in data communication with said application service computer processor.

3. The system of claim 1, wherein at least one of said electronic personal statement files is stored on said data storage device.

4. The system of claim 1, wherein said institution manager engine is adapted to provide said at least one institution computer access to said application information over said computer network.

5. The system of claim 4, wherein said institution manager engine is further configured to present to an institution user using said institution computer said electronic link to said electronic application personal statement file.

6. The system of claim 5, wherein upon said institution user engaging said electronic link to said electronic application personal statement file, said electronic personal statement file is displayed on said institution computer.

7. The system of claim 1, wherein said computer network comprises a wide area network.

8. The system of claim 7, wherein said wide area network comprises the World Wide Web.

9. The system of claim 1, wherein in order to review said electronic personal statement file, said institution user does not require separate media reviewing equipment or separate physical storage for the electronic personal statement file other than said institution computer.

10. The system of claim 1, wherein said electronic personal statement file further comprises an electronic media file selected from the group consisting of a video file, a live video, an electronic slide presentation, an electronic image, electronic animation, and combinations thereof.

11. A method of processing electronic application forms over a computer network comprising the steps of:
receiving application information from an applicant over a computer network, said application information including an electronic link to an electronic application personal statement file, wherein said electronic application personal statement file is stored as a separate file from said application information; and
producing an electronic application including said electronic link and at least a portion of said application information.

12. The method of claim 11, wherein said electronic application personal statement file is stored on a third party media computer server.

13. The method of claim 11, wherein said electronic application personal statement file is stored on a data storage device in communication with an application service computer processor that receives said application information.

14. The method of claim 11, further comprising the step of receiving a selection from said applicant of one or more institutions to which said electronic application is to be distributed.

15. The method of claim 14, further comprising the step of providing said one or more institutions access to said electronic application from an institution computer over said computer network.

16. The method of claim 15, further comprising the step of presenting to an institution user using said institution computer said electronic link to said electronic personal statement file.

17. The method of claim 16, further comprising the step of:
in response to said institution user engaging said electronic link to said electronic application personal statement file, presenting said electronic personal statement file on said institution computer.

18. The method of claim 11, wherein said computer network comprises a wide area network.

19. The method of claim 18, wherein said wide area network comprises the World Wide Web.

20. The method of claim 11, wherein in order to review said electronic personal statement file, said institution user does not require separate media reviewing equipment or separate physical storage for the electronic personal statement file other than said institution computer.

21. The method of claim 11, wherein said electronic personal statement file further comprises an electronic media file selected from the group consisting of a video file, a live video, an electronic slide presentation, an electronic image, electronic animation, and combinations thereof.

22. A method of processing electronic application forms over a computer network comprising the steps of:
providing an application service computer having a processor having executable computer code adapted to execute an application manager engine and an institution manager engine, and at least one data storage device in communication with said application service computer processor, said application service computer processor being in data communication with at least one applicant computer, at least one institution computer, and a collection of one or more electronic application personal statement files;
receiving application information from an applicant over a computer network, said application information including an electronic link to one of said electronic application personal statement files, wherein said electronic application personal statement files are stored as one or more separate files from said application information; and
producing an electronic application including said electronic link and at least a portion of said application information.

24. The method of claim 23, wherein at least one of said electronic application personal statement files is stored on a third party media computer server in data communication with said application service computer processor.

25. The method of claim 23, wherein at least one of said electronic application personal statement files is stored on said data storage device.

26. The method of claim 23, wherein said institution manager engine is adapted to provide said at least one institution computer access to said application information over said computer network.

27. The method of claim 26, wherein said institution manager engine is further configured to present to an institution user using said institution computer said electronic link to said one of said electronic application personal statement files.

28. The method of claim 27, wherein upon said institution user engaging said electronic link to said one of said electronic application personal statement files, said one of said electronic personal statement files is displayed on said institution computer.

29. The method of claim 23, wherein said computer network comprises a wide area network.

30. The method of claim 29, wherein said wide area network comprises the World Wide Web.

31. The method of claim 23, wherein in order to review said one of said electronic personal statement files, said institution user does not require separate media reviewing equipment or separate physical storage for the electronic personal statement file other than said institution computer.

32. The method of claim 23, wherein said electronic personal statement files each further comprise an electronic media file selected from the group consisting of a video file, a live video, an electronic slide presentation, an electronic image, electronic animation, and combinations thereof.

33. A method of reviewing an electronic application over a computer network comprising:
providing an institution computer having a processor having executable computer code adapted to receive and display electronic applications from a remote application service computer;
receiving an electronic application from said application service computer, said electronic application including an electronic link to an electronic application personal statement file, wherein said electronic application personal statement file is stored as a separate file from said electronic application; and
displaying said electronic application and said electronic application file at said institution computer.

34. The method of claim 33, wherein said electronic application personal statement file is stored on a third party media computer server in data communication with said remote application service computer processor.

35. The method of claim 33, wherein said electronic application personal statement file is stored on a data storage device at said remote application service computer.

36. The method of claim 33, wherein said computer network comprises a wide area network.

37. The method of claim 36, wherein said wide area network comprises the World Wide Web.

38. The method of claim 33, wherein in order to review said electronic personal statement file, a user of said institution computer does not require separate media reviewing equipment or separate physical storage for the electronic personal statement file other than said institution computer.

39. The method of claim 33, wherein said electronic personal statement file further comprises an electronic media file selected from the group consisting of a video file, a live video, an electronic slide presentation, an electronic image, electronic animation, and combinations thereof.
